(19) United States
(12) Patent Application Publication
(10) Pub. No.: US 2005/0246715 A1
(43) Pub. Date: Nov. 3, 2005

(54) Distributed object processing system and method

(76) Inventor: Dominic Herity, County Meath (IE)

Correspondence Address: JACOBSON HOLMAN PLLC, 400 SEVENTH STREET N.W., SUITE 600, WASHINGTON, DC, 20004, US

(21) Appl. No.: 11/151,296

(22) Filed: Jun. 14, 2005

(30) Foreign Application Priority Data
Dec. 19, 2002 (IE) 2002/0980

(51) Int. Cl. G06F 9/46

(52) U.S. Cl. 719/315; 719/330

(57) ABSTRACT

A distributed object processing system has nodes with application objects and proxy objects for invoking actions on application objects. Each proxy object has a common, fixed length node identifier identifying the node on which its associated application object resides, and a common fixed length object identifiers identifying the associated application object within the node. Processing of the proxy object is thus very fast.

### FIELD OF THE INVENTION

The invention relates to distributed object processing in computer systems, and more particularly remote method invocation.

### PRIOR ART DISCUSSION

Distributed object invocation is described in “Distributed Systems Concepts and Design, Third Edition”, Coulouris, Dollimore and Kindberg, Addison Wesley, 2001, ISBN 0-201-61918-0, pp 165-182. A computational model consists of a set of nodes, each capable of sending a message to any other node. A node consists of a memory containing executable machine code, a memory containing data and a processor which executes the machine code. Each node typically has a separate hardware system. The machine code contains a set of application classes and each application class contains a set of methods. A method is called with a pointer to an object of the same application class as one of the parameters to the call and the other parameters depending on the particular method.

For some application classes, there exist corresponding proxy classes, whose proxy objects are used to perform distributed object invocations on the corresponding application objects. Both application objects and the proxy objects that refer to them may be stored on any node. A proxy class has methods that correspond to some of the methods of the application class.

The following is a typical invocation scenario, referring to Fig. A.
1. A server thread on a server node waits for an object request message using a semaphore.
2. A method is called on a proxy object on the client node.
3. The proxy method determines that the object to be invoked is located on another node. It constructs a remote invocation message from the parameters and proxy object value and calls a transport object with the message.
4. The transport object constructs a packet for transmission from the node identifier and the message. It sends the packet to the client node's I/O device.
5. The packet is transmitted from the client node to the server node.
6. The proxy method waits for the reply to the packet using a semaphore.
7. The i/o device on the server node issues an interrupt and activates an interrupt routine.
8. The interrupt routine signals a semaphore that a server thread is waiting on, making it runnable. This requires the operating system scheduler to run.
9. The server thread reads and interprets the remote invocation message.
10. The server thread calls the appropriate method on the appropriate application object using the parameters supplied in the message.
11. The server thread constructs a reply message from the return value of the method call and passes it to the transport object.
12. The server node transport object writes a packet to the server node I/O device.
13. The server thread waits for the next remote invocation message.
14. The packet is transmitted from the server node to the client node.
15. The client node I/O device issues an interrupt and activates the interrupt routine.
16. The interrupt routine signals the semaphore that the proxy method is waiting on, causing the proxy method to resume execution.
17. The proxy method reads the reply message and returns the appropriate value from the method call.

Problems with the prior approaches are that there is a long and complex set of steps required for an object invocation, imposing a high processor overhead. For example, this involves processing a variable-length proxy object involving dynamic memory allocation and string parsing. This increases transmission time and consumes network bandwidth.

The invention is directed towards providing an improved distributed object processing method and system.

### SUMMARY OF THE INVENTION

According to the invention, there is provided a distributed object processing system comprising a plurality of nodes on which reside application objects, and proxy objects instantiated from proxy classes for use in invoking methods of application objects, and in which each proxy object is associated with an application object, wherein the proxy objects include as attributes:
(a) a common and fixed length node identifier of the node on which its associated application object resides; and
(b) a common and fixed length object identifier which uniquely identifies the associated application object within the node.

Because the proxy objects have common fixed-length node and object identifiers they can be copied with no change except perhaps endian-swapping of the node identifier when transferring between nodes. Both the original proxy object and an arbitrary number of copies can be used on an arbitrary number of nodes.

In one embodiment, said node and object identifiers have the same length.

In another embodiment, the length of the node identifier or the object identifier is 32 bits.

In a further embodiment, the length of the node identifier or of the object identifier is 64 bits.

In one embodiment, methods of the proxy classes use the object identifier to make a direct call to the application object's method without table look-up or pointer indirection if the node identifier indicates that the invoked application object resides on the same node as the proxy object.

In another embodiment, at least some proxy objects have an in-line method which is identified in source code of the system as being of an inline category and which can be directly expanded by a compiler to determine more quickly if an invoked application object is on the same node or on a different node.

In a further embodiment, at least some proxy objects have a method which alters a processor stack frame and executes a jump instruction to an application object method without building a new stack frame.

In one embodiment, the proxy object method modifies a parameter of an existing stack frame.

In another embodiment, at least some proxy object methods copy part of a stack frame without interpretation into a request message.

In a further embodiment, at least one node communicates at least some method addresses of at least some of its application objects.

In one embodiment, kernels of the other nodes store these addresses for ongoing use during invocations without need for a server node to provide an application method address.

In another embodiment, the node broadcasts the addresses to other nodes.

In a further embodiment, the node sends the address in response to a request.

In one embodiment, at least one node includes source code identifying some application object methods as being in a fast category, and interrupt routines call these methods directly without being scheduled in an operating system.

In another embodiment, at least one node comprises a client thread which remains executing while awaiting invocation completion.

In a further embodiment, the proxy objects contain only the node and object identifiers, having no additional state.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:—

FIGS. 1 and 2 are message transfer diagrams illustrating the invention.

### DESCRIPTION OF THE EMBODIMENTS

Overview

In a distributed object processing system of the invention there are the following.
(a) Application classes, for each of which there is one proxy class.
(b) Application objects, for each of which there are one or more proxy objects.
(c) Application methods, for each of which there is one proxy method.

In general terms, if an application object O1 wishes to invoke a method on an application object O2, O1 calls the corresponding method on a proxy object R2 which refers to O2. Typically, other proxy objects will also refer to O2. The proxy object R3 consists of two attributes namely:
a fixed length identifier of the node on which its associated application object resides, and
a fixed length identifier which uniquely identifies this application object in its node.

A method M2 of R2 has parameters to call a corresponding method M2 on O2. For every application class there is a corresponding proxy class with corresponding methods. Corresponding methods have the same names and take the same parameters. R2's method M2 determines if O2 is local (on the same node). If so it has its address and calls it. The address is of fixed length. If O2 is remote R2's method M2 constructs a message and calls the kernel of R2's node to deliver this message. R2 encodes this message with M2's parameters and passes the message to the kernel. The kernel transmits the message to the server node. The kernel determines the server node from the node identifier attribute of R2. The kernel of the server node decodes the message, determines O2's address from the R2 attribute in the message, and calls it. The server kernel then constructs a response message, which is sent back to the client node. R2's method M2 receives the response message, decodes it, and returns the return value encoded in the response to O1.

In the above, O2's method is called for the outgoing invocation message by virtue of the server kernel informing the client kernel of this method's address. The server kernel communicates the method address to the client kernel before the invocation takes place. The client kernel puts this address into the message. This communication from the server kernel only needs to be performed once per epoch (server start-up), although it may be done more frequently, if desired. The client kernel typically caches the method address for use on multiple calls to the same method on the same server.

Efficient Proxy Object

In more detail, distributed object programs deal a lot with proxy objects. Computations are performed by acquiring proxy objects and calling methods on them. Each method call includes at least one proxy object and many contain more than one. Object proxies need to be copied, converted to object pointers and used to determine object location.

In the prior art, proxy objects are not particularly efficient. Consider for example CORBA, “Common Object Request Broker Architecture (CORBA)”, Version 2.4.2, Object Management Group, February 2001, Section 13.6, which specifies a complex, variable length, information rich proxy object—the Interoperable Object Reference (IOR). IORs can run to hundreds of bytes in size.

A proxy object of the invention has as its attributes (data) a duple consisting of two fixed size components, one a pointer to an application object and the other an identifier of the node of that application object. Conversion to a pointer is fast since the pointer is contained in the proxy object. It is also fast to determine if an object is local, since this requires comparing node identifiers, which takes only a few instructions. The pointer and the identifier are of a fixed length such as 32 or 64 bits, which length is common across all proxy objects in the system.

The node identifier is used on the client node to discriminate between a local invocation and a remote invocation and to access per-node information needed to accomplish a remote invocation.

A proxy object is fast to copy because its size is small and fixed and because no additional computation is needed apart from reading and writing the state.

The following is C++ sample code to describe another aspect of the invention more fully. The NodeManager class is part of the kernel. The TestClass is an application class having a method “addEm”. The corresponding proxy class is TestClassProxy. This has a method “addem” which determines if the server node is the current node and calls it directly if it is. The attributes of a TestClassProxy consist only of the node identifier and the object identifier. The method “addEm” of this proxy class is an in-line function which is expanded in-line by the compiler. It determines if the application object being invoked is local or remote, and calls it directly if it is local.

| | |
|---|---|
| 1. | ///////////////////////////////////////////////////// |
| 2. | class NodeManager { |
| 3. | private: |

| | |
|---|---|
| 4. | static int thisNodeId_; |

| | |
|---|---|
| 5. | public: |

| | |
|---|---|
| 6. | inline static int thisNodeId( ) { |

| | |
|---|---|
| 7. | return thisNodeId_; |

| | |
|---|---|
| 8. | } |
| 9. | // . . . |

| | |
|---|---|
| 10. | }; |
| 11 | ///////////////////////////////////////////////////// |
| 12. | class TestClass { |
| 13. | public: |

| | |
|---|---|
| 14. | int addEm(int x, int y, int z); |
| 15. | // . . . |

| | |
|---|---|
| 16. | }; |
| 17. | ///////////////////////////////////////////////////// |
| 18. | class TestClassProxy { |
| 19. | public: |

| | |
|---|---|
| 20. | // . . . |
| 21. | inline int addEm(int x, int y, int z) { |

| | |
|---|---|
| 22. | if (nodeId_ == NodeManager::thisNodeId( )) |

| | |
|---|---|
| 23. | return offset_->addEm(x, y, z); |

| | |
|---|---|
| 24. | // Remote invocation . . . |

| | |
|---|---|
| 25. | } |

| | |
|---|---|
| 26. | private: |

| | |
|---|---|
| 27. | int nodeId_; |
| 28. | TestClass* offset_; |
| 29. | // . . . |

| | |
|---|---|
| 30. | }; |

The determination calls two inline functions that return integers, so the determination amounts to two memory reads and an integer compare—typically three machine code instructions in all. The local invocation requires the object pointer to be extracted from the proxy object—a simple memory read.

Stack Frame Copying to Speed Marshaling

In general, different nodes may have different processor architectures, different operating systems, different languages or different compilers. This means that the parameters of methods may have to be converted during remote invocation. This conversion is done by proxy objects and by server threads. Conversions that may be necessary include big-endian<->little-endian swapping, word size conversions (e.g. 32 bit<->64 bit), Unicode<->ASCII, and differences in struct layout between different compilers. For this reason, each parameter or return value may have to be altered in a way that depends on its type and on node differences.

However, it is common for client and server nodes to have the same processor architecture and compiler. Where this is the case, the stack frame passed to the proxy object method on the client node is re-constructed almost exactly the same by the server thread on the server node. In such cases, in the invention the proxy method simply copies part of the stack frame without interpretation into a request message and the server thread similarly copies from the received message to the stack frame.

Method Pointer Distribution

As stated above, the server node supplies the client node with the method pointer before a remote invocation to that particular method on that particular server node is performed. This pointer then serves as the method indicator in request messages, which eliminates the conversion step. This is subsequently used many times.

In one embodiment, each node broadcasts all its method pointers to all other nodes during initialisation. In another embodiment, the client node requests it from the server node in a preamble to the first call on that particular method on that particular server node from that particular client node.

Jump to Local Invocation

Where an object invocation is to a local object, the invocation can be performed by altering the stack frame and executing a jump instruction to the appropriate method. This is faster than calling the methods, which entails building a new stack frame, calling the method, and returning.

The following code illustrates a jump to local invocation. The example involves some C++ source code and a disassembly of the machine code generated from it. The C++ source code involves three functions—a function f(TestClassProxy) that calls a method on a proxy class TestClassProxy with parameters. This method examines the proxy object to determine if the object is local. If the object is local, it computes a pointer to the object, calls the TestClass method with the same parameters and returns the result.

1.

| | |
|---|---|
| 2. | int f(TestClassproxy t) { |

| | |
|---|---|
| 3. | return t.addEm(1, 2, 3); |

| | |
|---|---|
| 4. | } |
| 5. | |
| 6. | f(TestClassProxy): |

| | | | |
|---|---|---|---|
| 7. | +0: | push | %ebp |
| 8. | +1: | mov | %esp, %ebp |
| 9. | +3: | sub | $0x18, %esp |
| 10. | +6: | mov | 0x8(%ebp), %eax |
| 11. | +9: | mov | 0xc(%ebp), %edx |
| 12. | +12: | mov | %eax, 0xfffffff8 (%ebp) |
| 13. | +15: | mov | %edx, 0xfffffffc (%ebp) |
| 14. | +18: | lea | 0xfffffff8 (%ebp), %eax |
| 15. | +21: | push | $0x3 |
| 16. | +23: | push | $0x2 |
| 17. | +25: | push | $0x1 |
| 18. | +27: | push | %eax |
| 19. | +28: | call | addEm 14TestClassProxyiii |
| 20. | +33: | mov | %ebp, %esp |
| 21. | +35: | pop | %ebp |
| 22. | +36: | ret | |
| 23. | | | |

| | |
|---|---|
| 24. | inline int TestClassProxy::addEm(int x, int y, int z) { |

| | |
|---|---|
| 25. | if ref .node( ) == NodeManager:thisNodeId( )) |

| | |
|---|---|
| 26. | return offset ->addEm(x, y, z); |

| | |
|---|---|
| 27. | // . . . |

| | |
|---|---|
| 28. | { |
| 29. | |
| 30. | TestClassProxy::addEm(int, int, int): |

| | | | |
|---|---|---|---|
| 31. | +0: | push | %ebp |
| 32. | +1: | mov | %esp, %ebp |
| 33. | +3: | mov | 0x413000, %eax |
| 34. | +8: | sub | $0x8, %esp |
| 35. | +11: | mov | 0x8(%ebp), %edx; this -> %edx |
| 36. | +14: | cmp | %eax, (%edx) |
| 37. | +16: | ine | addEm 14TestClassProxyiii+50 |
| 38. | | | |
| 39. | +18: | mov | 0x14(%ebp), %eax |
| 40. | +21: | push | %eax |
| 41. | +22: | mov | 0x10(%ebp), %eax |
| 42. | +25: | push | %eax |
| 43. | +26: | mov | 0xc(%ebp), %eax |
| 44. | +29: | push | %eax |
| 45. | +30: | mov | 0x4(%edx), %eax |
| 46. | +33: | push | %eax |
| 47. | +34: | call | addEm 9TestClassiii |
| 48. | +46: | mov | %ebp, %esp |
| 49. | +48: | pop | %ebp |
| 50. | +49: | ret | |

| | | |
|---|---|---|
| 51. | +50: | ; // . . . |
| 52. | | |

| | |
|---|---|
| 53. | int TestClass::addEm(int x, int y, int z) { |

| | |
|---|---|
| 54. | return state + x + y + z; |

| | |
|---|---|
| 55. | } |
| 56. | |
| 57. | TestClass::addEm(int. int, int): |

| | | | |
|---|---|---|---|
| 58. | +0: | push | %ebp |
| 59. | +1: | mov | %esp, %ebp |
| 60. | +3: | mov | 0x8(%ebp), %eax |
| 61. | +6: | mov | (%eax), %eax |
| 62. | +8: | add | 0xc(%ebp), %eax |
| 63. | +11: | add | 0x10(%ebp), %eax |
| 64. | +14: | add | 0x14(%ebp), %eax |
| 65. | +17: | mov | %ebp, %esp |
| 66. | +19: | pop | %ebp |
| 67. | +20: | ret | |
| 68. | | | |

The above shows the C++ source code is interspersed with disassembled machine code. The disassembly is in the Intel Pentium™ instruction set and is generated by a C++ compiler from the interspersed source code. Lines 1-4 show the function f( ) and lines 5-23 show the corresponding disassembly. This disassembly illustrates the construction of a stack frame for the method TestClassProxy::addEm(int, int, int). The three int parameters are pushed onto the stack, then the pointer to the TestClassProxy object, then TestClassProxy::AddEm is called, which results in the return address being pushed onto the stack.

Lines 24-28 show part of the method TestClassProxy::addEm(int, int, int). At line 25, it determines whether the application object is local. If it is, line 26 computes a pointer to the local TestClass object, calls its addEm method and returns the result. If the object is not local, other code is executed. Lines 30-53 show the machine code implementation of TestClassProxy::addEm(int, int, int). Lines 33-37 determine whether the application object is local and lines 39-50 implement line 26. Lines 53-55 show the method TestClass::addEmm(int, int, int) and lines 56-66 show its implementation. This illustrates how the method accesses its parameters in the stack frame.

A further optimisation involves replacement of machine code fragments like those represented by lines 30-50 with code like lines 1-15 below. This fragment is the same in the first ten lines, but lines 39-50 are replaced with lines 11-14. Instead of copying parameters from one stack frame to a new stack frame, calling a function and returning, the fragment modifies one parameter in the existing stack frame then jumps into TestClass::addEm(int, int, int), which will then return directly to the function that called TestClassProxy::addEm(int, int, int).

| | |
|---|---|
| 1. | ; Modified TestClassProxy::addEm |
| 2. | TestClassProxy::addEm(int, int. int): |

| | | | |
|---|---|---|---|
| 3. | +0: | push | %ebp |
| 4. | +1: | mov | %esp, %ebp |
| 5. | +3: | mov | 0x413000, %eax |
| 6. | +8: | sub | $0x8, %esp |
| 7. | +11: | mov | 0x8(%ebp), %edx |
| 8. | +14: | cmp | %eax, (%edx) |
| 9. | +16: | ine | addEm 14TestClassProxyiii+29 |
| 10. | | | |
| 11. | +18: | mov | 0x8(%ebp), %eax |
| 12. | +21: | mov | 0x4(%eax), %eax |
| 13. | +24: | mov | %eax, 0x4(%ebp); replace this |
| 14. | +27: | imp | addEm 9TestClassiii+3 |

| | | |
|---|---|---|
| 15. | +29: | ; // . . . |

Execution time saved depends on processor architecture, machine code details and other factors, but it can be estimated by comparing the instructions executed and the memory accesses needed with the machine code it replaces. In this example, 13 instructions and 9 memory accesses are saved. Typically, this method saves 2N+4 instructions and 2N+3 memory accesses per local invocation where N is the number of parameters to the method.

To implement this technique, the machine code for the proxy method is modified after compilation. This can be done either by a specialized optimiser or by an entity that alters the machine code during initialisation.

Fast Methods Executed in Interrupt Routines

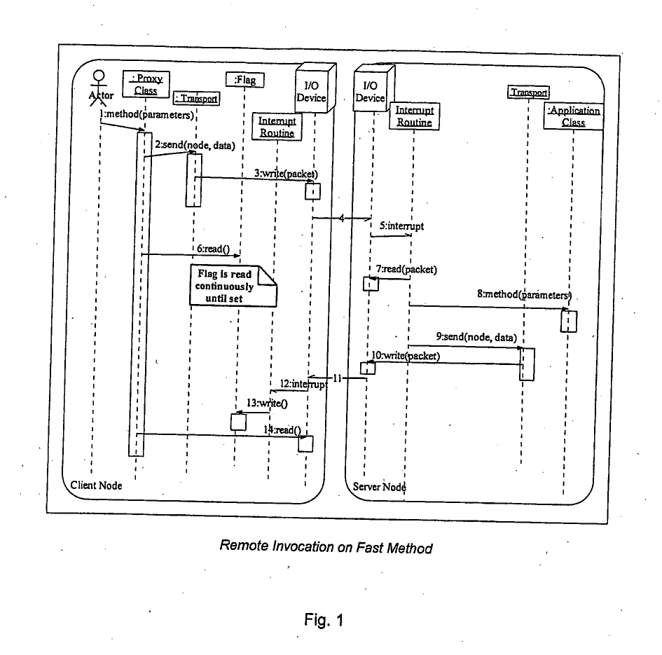

Some methods are identified in the source code as being ‘fast’. This means that they have a short execution time and that they may be called from an interrupt routine. Such methods can be called directly from an interrupt routine, rather than being scheduled by the operating system, which speeds execution. For a further speed improvement, the client thread can remain running while awaiting invocation completion, rather than blocking. This is illustrated in FIG. 1.

The sequence of events is:
1. A method is called on a proxy object on the client node.
2. The proxy object determines that the object is located on another node. It constructs a remote invocation message from the parameters and proxy object value and calls the transport object with the message.
3. The transport object constructs a packet for transmission from the node identifier and the message. It sends the packet to the I/O device.
4. The packet is transmitted from the client node to the server node.
5. The I/O device on the server node issues an interrupt and activates the interrupt routine.
6. The proxy object waits for the reply to the packet by continuously polling a flag waiting for it to be set by an interrupt routine.
7. The interrupt routine reads and interprets the remote invocation message.
8. The interrupt routine calls the appropriate method on the appropriate application object using the parameters supplied in the message.
9. The interrupt routine constructs a reply message from the return value of the method call and passes it to the transport object.
10. The server node transport object writes a packet to the server node I/O device.
11. The packet is transmitted from the server node to the client node.
12. The client node I/O device issues an interrupt and activates the interrupt routine.
13. The interrupt routine sets the flag that is polled by the proxy method.
14. The proxy method reads the reply message and returns the appropriate value from the method call.

This is more efficient than the prior art 17-step sequence referring to Fig. A because the “fast” methods are called directly from an interrupt routine.

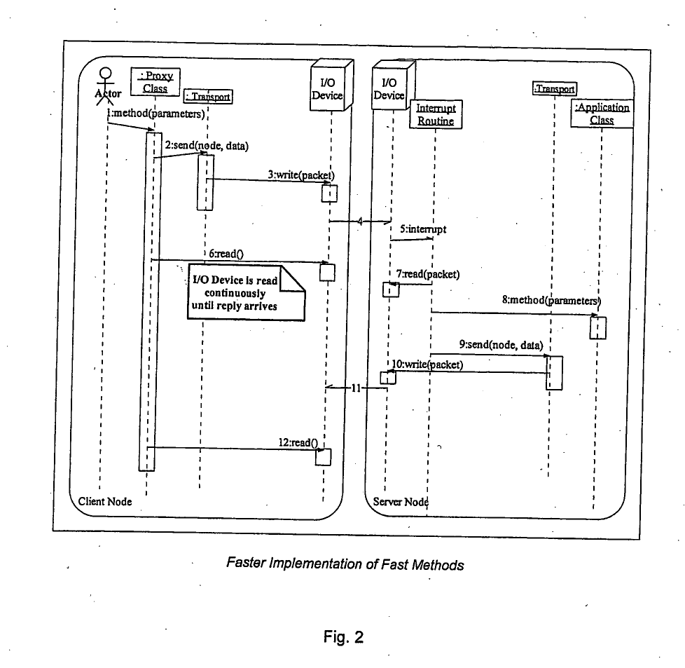

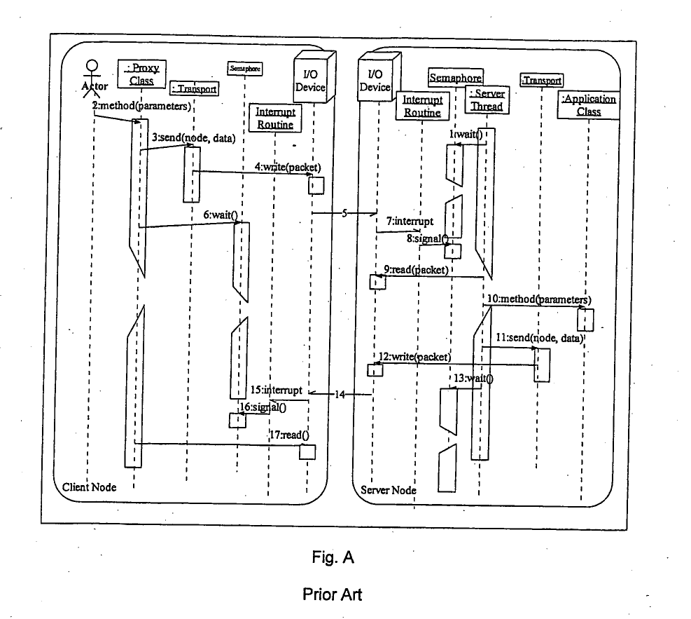

A further improvement is illustrated in FIG. 2. Here, the client node interrupt is eliminated and the I/O device is instead polled for a reply. This is achieved because the client thread remains running while awaiting invocation completion, rather than blocking. It will be appreciated that the proxy objects are small and simple to copy. Indeed, they can be created, copied, and destroyed without the node kernel, this being instead performed by a proxy class.

The invention is not limited to the embodiments described but may be varied in construction and detail. In another embodiment, the node identifier and the pointer don't have to be the same size. The important point is that they are each fixed in size and that the local invocation can be identified with a single compare instruction. Also, instead of a pointer, a table index can be used. This table is stored on the same node as the object and need never be remotely accessed. The table index has the advantage over a pointer that it can be smaller, allowing the proxy object to be smaller.

1. A distributed object processing system comprising a plurality of nodes on which reside application objects, and proxy objects instantiated from proxy classes for use in invoking methods of application objects, and in which each proxy object is associated with an application object, wherein the proxy objects include as attributes:
(a) a common and fixed length node identifier of the node on which its associated application object resides; and
(b) a common and fixed length object identifier which uniquely identifies the associated application object within the node.

2. The system as claimed in claim 1, wherein said node and object identifiers have the same length.

3. The system as claimed in claim 1, wherein the length of the node identifier or the object identifier is 32 bits.

4. The system as claimed in claim 1, wherein the length of the node identifier or of the object identifier is 64 bits.

5. The system as claimed in claim 1, wherein methods of the proxy classes use the object identifier to make a direct call to the application object's method without table look-up or pointer indirection if the node identifier indicates that the invoked application object resides on the same node as the proxy object.

6. The system as claimed in claim 1, wherein at least some proxy objects have an in-line method which is identified in source code of the system as being of an inline category and which can be directly expanded by a compiler to determine more quickly if an invoked application object is on the same node or on a different node.

7. The system as claimed in claim 1, wherein at least some proxy objects have a method which alters a processor stack frame and executes a jump instruction to an application object method without building a new stack frame.

8. The system as claimed in claim 6, wherein the proxy object method modifies a parameter of an existing stack frame.

9. The system as claimed in claim 1, wherein at least some proxy object methods copy part of a stack frame without interpretation into a request message.

10. The system as claimed in claim 1, wherein at least one node communicates at least some method addresses of at least some of its application objects.

11. The system as claimed in claim 9, wherein kernels of the other nodes store these addresses for ongoing use during invocations without need for a server node to provide an application method address.

12. The system as claimed in claim 9, wherein kernels of the other nodes store these addresses for ongoing use during invocations without need for a server node to provide an application method address; and wherein the node broadcasts the addresses to other nodes.

13. The system as claimed in claim 11, wherein the node sends the address in response to a request.

14. The system as claimed in claim 1, wherein at least one node includes source code identifying some application object methods as being in a fast category, and interrupt routines call these methods directly without being scheduled in an operating system.

15. The system as claimed in claim 13, wherein at least one node comprises a client thread which remains executing while awaiting invocation completion.

16. The system as claimed in claim 1, wherein the proxy objects contain only the node and object identifiers, having no additional state.

17. A method of operation of a distributed object processing system comprising a plurality of nodes on which reside application objects, and proxy objects instantiated from proxy classes for use in invoking methods of application objects, and in which each proxy object is associated with an application object, in which the proxy objects uses:
a common and fixed length node identifier of the node on which its associated application object resides; and
a common and fixed length object identifier which uniquely identifies the associated application object within the node.

18. The computer program product comprising software code for performing operations of a distributed object processing method of claim 16 when executing on a digital computer.
